(19) United States
(12) Patent Application Publication
(10) Pub. No.: US 2017/0357312 A1
(43) Pub. Date: Dec. 14, 2017

(54) FACILITATING SCANNING OF PROTECTED RESOURCES

(71) Applicant: HEWLETT- PACKARD DEVELOPMENT COMPANY, LP., HOUSTON, TX (US)

(72) Inventor: INGO RAUM, FUERTH (DE)

(21) Appl. No.: 15/535,834

(22) PCT Filed: Mar. 2, 2015
(86) PCT No.: PCT/US15/18233

§ 371 Date: Jun. 14, 2017

(51) Int. Cl. G06F 3/01; G06T 19/00

(52) U.S. Cl. CPC G06F 3/013; G06T 19/006; G09G 2354/00

(57) ABSTRACT

An example disclosed herein determines a position of a user relative to a display of a media device using a first camera of the media device, identifies a target surface from in the image stream captured by a second camera of the media device, the second camera to adjust settings for an image stream captured by the camera based on the position of the user, and presents the adjusted image stream on the display to include a virtual display projected onto the target surface.

### BACKGROUND

Displays of media devices (e.g., mobile phones, tablets, media players, personal digital assistants (PDA), etc.) may be utilized to present media (e.g., video, images, documents, text, etc.) to a user. For example, a user may watch videos, view images, etc. using a media device. The display may be a touchscreen, a light emitting diode (LED) display, an organic LED (OLED) display, a liquid crystal display (LCD), or any other suitable type of display. The media devices may also include a camera or other sensors, such as depth sensors, accelerometers, etc. The example camera of the media device may adjust settings to exposure of images captured by the camera (e.g., wide angle, straight view, panoramic etc.).

### BRIEF DESCRIPTION OF THE DRAWINGS

FIG. 1 illustrates an example environment in which a media device including an example virtual display projector may be implemented in accordance with an aspect of this disclosure.

FIG. 2 is a block diagram of an example implementation of the example media device of FIG. 1 that includes an example virtual display projector constructed in accordance with an aspect of this disclosure.

FIG. 3 is a block diagram of an example virtual display projector that may be used to implement the virtual display projector of FIG. 2.

FIGS. 4A, 4B, and 4C illustrate an example virtual display projection implemented by the example virtual display projector of FIG. 2 or 3.

FIGS. 5A and 5B illustrate an example virtual display projection onto a target surface based on a distance between a user and a media device implementing the virtual display projector of FIG. 2 or 3.

FIG. 6 is a flowchart representative of example machine readable instructions that may be executed to implement the virtual display projector of FIG. 3.

FIG. 7 is a block diagram of an example processor platform capable of executing the instructions of FIG. 6 to implement the virtual display projector of FIG. 3.

Wherever possible, the same reference numbers will be used throughout the drawing(s) and accompanying written description to refer to the same or like parts. As used in this patent, stating that any part (e.g., a layer, film, area, or plate) is in any way positioned on (e.g., positioned on, located on, disposed on, or formed on, etc.) another part, means that the referenced part is either in contact with the other part, or that the referenced part is above the other part with at least one intermediate part located therebetween. Stating that any part is in contact with another part means that there is no intermediate part between the two parts.

### DETAILED DESCRIPTION

Examples disclosed herein involve projecting a virtual display on a display of a media device. In examples disclosed herein, a target surface is identified in an image stream (or video capture) from a camera and media is projected onto the target surface within the image stream and presented on a display of the media device. In examples disclosed herein, the projection of the virtual display may be adjusted based on a position of a user or a position of the media device relative to the identified target surface. In examples disclosed herein, camera settings may be adjusted to project the virtual display on the target surface within the image stream such that the media appears to be projected onto the target surface when viewed on a display of the media device. In some examples, the projected virtual display may appear static such that when a user moves or the media device moves, the projected virtual display on the target surface does not appear to move. In examples disclosed herein, the virtual display projected on the target surface may allow portions of the media to be viewable or not to be viewable on the display of the media device depending on the movement of the user or the movement of the media device relative to the virtual display on, the target surface.

Users frequently view media using handheld devices having a relatively small screen (e.g., less than 20 inches). For example, a user may choose to read a book or watch a movie on a mobile device that has less than a five inch display. Examples disclosed herein create an optical illusion of enhancing a size of media presented on a display of a media device (e.g., a smartphone, a media player, a tablet computer, a personal digital assistant (PDA), etc.). An example virtual display projector augments media onto a target surface of an image stream from a camera of the media device. For example, the camera streams an image of a wall or desk top. In such an example, the wall or desktop may serve as a target surface on which the virtual display projector may project the media in accordance with the teachings of this disclosure. Projection of the media on the virtual surface may give the user a perception of an increased size of the display on the media device. In some examples, the virtual projection displayed on the display of the media device may be adjusted based on a position of a user or a position of the media device relative to the identified target surface.

An example method includes determining a position of a user viewing a display of a media device; identifying a target surface for a virtual display in an image stream from a camera of the media device; adjusting settings for the camera based on the position of the user; and presenting the image stream to include the virtual display appearing on the target surface based on the position of the user and the position of the media device

As used herein, a target surface may be any identifiable surface within an image or image stream (video). An example target surface may have a specified border or boundary or be borderless or have no boundaries. As used herein, a virtual projection of media or virtually projecting media refers to an augmentation or augmenting the media onto a display or within an image stream presented by a display. As used herein, a front-facing camera is a camera on a media device focused toward the same side of the media device as a corresponding display of the media device and a rear-facing camera is a camera on the media device focused on a side of the media device opposite a display. Accordingly, an image stream from a rear-facing camera may give the user the optical illusion of being able to view through the display of the media device such that the media device appears transparent (e.g., similar to a window).

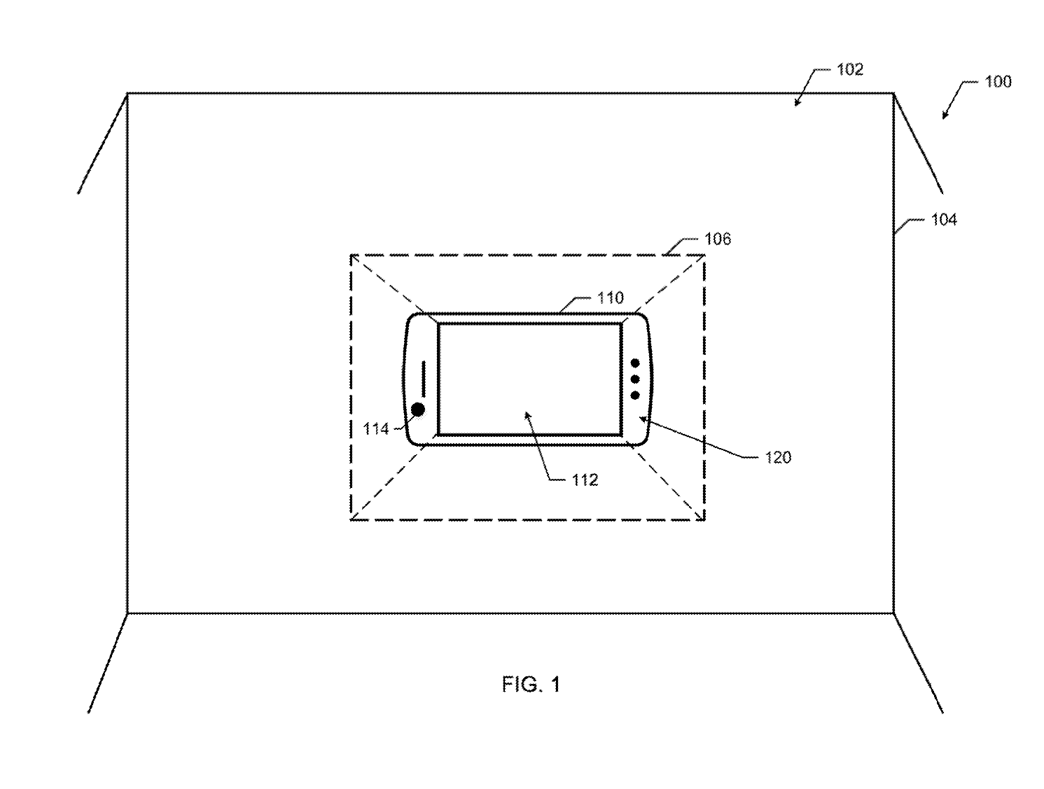

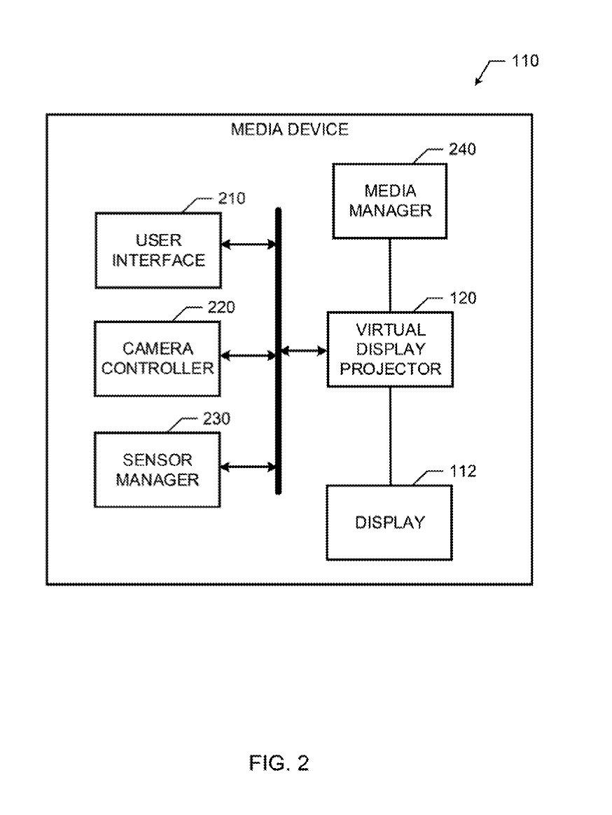

FIG. 1 illustrates an example environment 100 in which a media device 110 including an example virtual display projector 120 may be implemented. In FIG. 1, the environment 100 includes a room 102 with a wall 104. In the illustrated example of FIG. 1, the virtual display projector 120 of the media device may identify the wall 104 as a target surface for projecting a virtual display on a display 112 of the media device 110.

In the illustrated example of FIG. 1, the example media device 110 includes a display 112, a front-facing camera 114, and the virtual display projector 120. The example media device 110 may by any type of media device 110, such as a smartphone, a tablet computer, a personal digital assistant (PDA), an mp3 player, etc. The media device 110 also includes a rear-facing camera on an opposing side of the media device 110 as the display 112. Accordingly, the rear-facing camera may capture an image of the wall while the front-facing camera 114 may capture an image of a user or anything on the same side of the media device 110 as the display. The example display 112 of the media device may be any type of display, such as a light emitting diode (LED) display, an organic LED (OLED) display, a liquid crystal display, or the like. Accordingly, the display may include a substrate layer (e.g., glass or plastic), a pixel layer (e.g., including an array of LEDs, an array of liquid crystal etc.), a reflection layer, a back plate, or any layer for implementing the display 112 of the media device 110. Accordingly, in examples disclosed herein, the display 112 may be a non-transparent display.

In the illustrated example of FIG. 1 a target surface 106 of the wall 104 (or target surface) is indicated as a location for virtual display projection in accordance with the teachings of this disclosure. In examples disclosed herein, the rear-facing camera of the media device 110 may identify the target surface 106 (e.g., a portion of the wall 104) to project a virtual display in an image stream to appear in or on the target surface. In some examples, the target surface may include an identifiable border (e.g., a frame of a screen or picture, a perimeter of a wall, etc.). The image stream may come from the rear-facing camera of the media device 110. Accordingly, the image stream may include media to be virtually projected on the target surface 106. For example, a user may view a video within or on the target surface 106 in an image stream from the rear-facing camera of the media device 110 on the display 112.

In examples disclosed herein, the virtual display projector 120 may determine a location of a user or a location of the media device 110 to identify a desired (e.g., a preferred or even best) target surface 106 for projection of a virtual display of media in an image stream from a camera of the media device 110. In some examples, the virtual display projector 120 may adjust camera settings based on a position of the user (e.g., a position relative to the media device 110) or a position of the media device 110 (e.g., relative to the target surface).

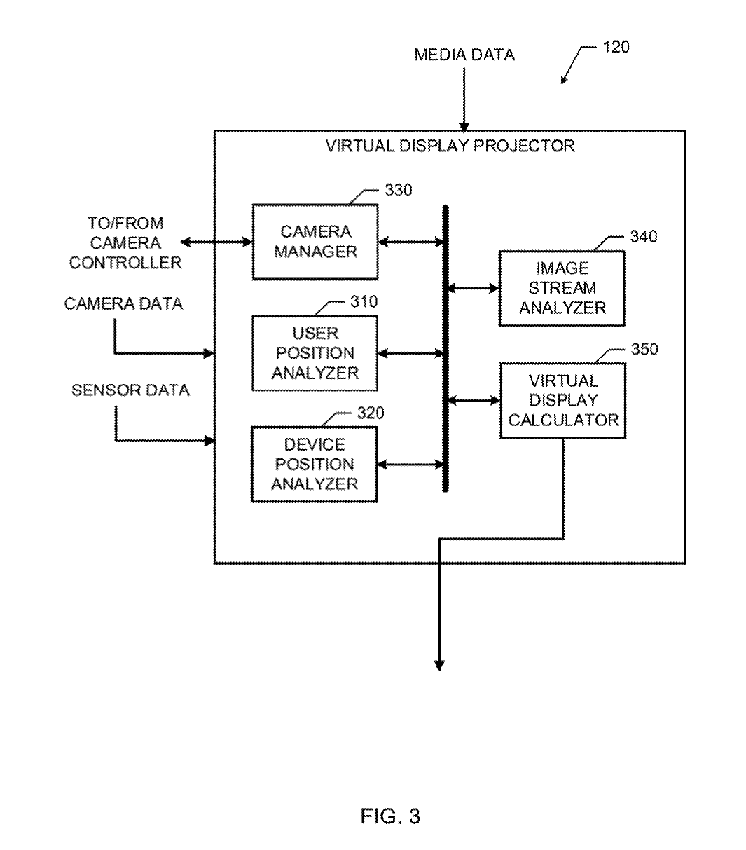

In examples disclosed herein, the example virtual display projector 120 may be implemented by a device located within (a storage medium or processor) or on the media device 110. In some examples, the virtual display projector 120 may be implemented by an application or other instructions executed by a machine (e.g., a processor) of the media device 110. Although the virtual display projector 120 is located on or within the media device 110 of FIG. 1, additionally or alternatively, the virtual display projector 120 may be partially or entirely located on an external device (e.g., a local server, a cloud server, etc.). In such examples, the virtual display projector 120 may receive information (e.g., user position, device position, an image stream, etc.) from the media device, insert a projected virtual display of media (e.g., a video, an image, a document, etc.) within an image stream of the media device 110, and return the image stream with the projected virtual display of the media to the user device. An example implementation of the virtual display projector 120 is disclosed below in connection with FIG. 3.

FIG. 2 is a block diagram of an example media device 110 that may be used to implement the media device 110 of FIG. 1. The example media device 110 of FIG. 2 includes a user interface 210, a camera controller 220, a sensor manager 230, a media manager 240, a display 112, and the virtual display projector 120. In examples disclosed herein, the virtual display projector 120 may receive information from the user interface 210, camera controller 220, and sensor manager 230 to generate a virtual display of media from the media manager 230 be projected within an image on the display 112. An example implementation of the virtual display projector 120 is further disclosed below in connection with FIG. 3.

The example user interface 210 of FIG. 2 enables a user to access the media device 110. For example, a user may activate or initiate the virtual display projector 120 (e.g., by selecting an icon, opening an application, powering on the media device 110, etc.). The example user interface 210 may include a touchscreen, buttons, a mouse, a track pad, etc. for controlling the media device 110. In some examples, the user interface 210 and the display 112 may be implemented by or associated with a same device (e.g., a touchscreen). The example user interface 210 may be used to select media to be virtually projected in an image stream as disclosed herein or used to select a target surface to be used to virtually project the selected media.

The camera controller 220 in the example of FIG. 2 controls a camera or a plurality of cameras of the media device 110. For example, the camera controller 220 may control settings (e.g., zoom, resolution, shutter speed, etc.) of one or a plurality of cameras (e.g., a front-facing camera and a rear-facing camera). In examples disclosed herein, the camera controller 220 may receive instructions or communicate with the virtual display projector 120 to adjust the settings of the camera(s) of the media device 110. For example, the camera controller 220 may adjust a zoom or view of a rear-facing camera of the media device from a wide angle zoom to a straight view. As another example, the camera controller 220 may receive instructions from the virtual display projector 120 to control a front-facing camera (i.e., a camera on the same side of a media device as a display of the media device) to capture images of a user or an eye gaze of the user. In examples disclosed herein, the camera controller 220 may receive the image(s) or image data from the camera(s) and provide the image(s) or image data to the virtual display projector 120 for analysis in accordance with the teachings of this disclosure.

The example sensor manager 230 may control sensors (e.g., a gyroscope, an accelerometer, a depth sensor, etc.) and receive measurement information from the sensors. For example, the sensor manager 230 may receive measurement information corresponding to a position or orientation information of the media device 110. The example sensor manager 230 may forward such information to the virtual display projector 120 for analysis in accordance with the teachings of this disclosure. In some examples, the sensor manager 230 may receive instructions from the virtual display projector 120 to take certain measurements or provide measurements from a particular sensor of the media device 110.

The example media manager 240 of FIG. 2 manages media of the media device 110. For example, the media manager 240 may include a database or storage device. The media manager 240 may facilitate retrieval of media (e.g., video, audio, images, text, documents, files, etc.) from the database or storage device and provide the media to the virtual display projector 120. For example, a user may request, via the user interface 210, to view media or stream media using the virtual display projector 120. In such examples, the virtual display projector 120 may facilitate retrieval of media from the media manager 240 (e.g., by utilizing a graphical user interface of the virtual display projector 120 or the user interface 210). For example, the media manager 240 provides media to the virtual display projector 120 to virtually project (or augment) the media within an image stream from a camera of the media device 110. In some examples, the media manager 240 is located externally from the media device 110 (e.g., on a cloud server).

The example display 112 of FIG. 2 may be used to implement the display 112 of the media device 110 of FIG. 1. In some examples, the display 112 may be implemented by or in accordance with the user interface 210 (e.g., as a touchscreen of the user interface). In examples disclosed herein, the display 112 may present media (e.g., a video, an image, a document, text, etc.) that is virtually projected (or augmented) onto a target surface in an image stream from a camera.

While an example manner of implementing the media device 110 of FIG. 1 is illustrated in FIG. 2, at least one of the elements, processes and/or devices illustrated in FIG. 2 may be combined, divided, re-arranged, omitted, eliminated and/or implemented in any other way. Further, the display 112, the virtual display projector 120, the user interface 210, the camera manager 220, the sensor manager 230, the media manager 240 or, more generally, the media device 110 of FIG. 2 may be implemented by hardware and/or any combination of hardware and executable instructions (e.g., software and/or firmware). Thus, for example, any of the display 112, the virtual display projector 120, the user interface 210, the camera manager 220, the sensor manager 230, the media manager 240 or, more generally, the media device 110 may be implemented by at least one of an analog or digital circuit, a logic circuit, a programmable processor, an application specific integrated circuit (ASIC), a programmable logic device (PLD) and/or a field programmable logic device (FPLD). When reading any of the apparatus or system claims of this disclosure to cover a software and/or firmware implementation, at least one of the display 112, the virtual display projector 120, the user interface 210, the camera manager 220, the sensor manager 230, and the media manager 240 is/are hereby expressly defined to include a non-transitory tangible machine readable medium (e.g., a storage device or storage disk such as a memory, a digital versatile disk (DVD), a compact disk (CD), a Blu-ray disk, etc.) storing the executable instructions. An example machine may include a processor, a computer, etc. Further still, the example media device 110 of FIG. 2 may include at least one element, process, and/or device in addition to, or instead of, those illustrated in FIG. 2, and/or may include more than one of any or all of the illustrated elements, processes and devices.

FIG. 3 is a block diagram of an example virtual display projector 120 that may be used to implement the virtual display projector 120 of FIG. 1 or 2 in accordance with the teachings of this disclosure. The example virtual display projector 120 of FIG. 3 includes a user position analyzer 310, a device position analyzer 320, a camera manager 330, an image stream analyzer 340 and a virtual display calculator 350. In examples disclosed herein, the virtual display projector 120 augments media onto a target surface or within a target area of the target surface within an image stream from a camera of a media device. In examples disclosed herein, the virtual display projector 120 may control a display of the media on the display 112 of the media device 110 such that the media appears to be projected onto the target surface. The virtual display projector 120 may control the display or camera settings of a camera (e.g., a rear-facing camera) providing the image stream based on a position of a user (or a user's eye gaze) or based on a position of the media device 110.

The example user position analyzer 310 analyzes a position of a user. For example, the user position analyzer 310 may determine a position of a user's face or an eye gaze of the user. In examples disclosed herein, the user position analyzer 310 may analyze images from the camera manager 330 or a camera of the media device 110 to determine a position of the user relative to the display 112 or to an identified target surface for a virtual display. Such a camera may be a front-facing camera that captures images of a user located on a same side of the media device 110 as the display 112. Accordingly, the user position analyzer 310 may include an image processor capable of recognizing or identifying a face or eyes (e.g., pupils, irises, etc.) of a user. By processing images of the user, the user position analyzer 310 may determine where a user is located relative to the display 112 or a direction of an eye gaze of the user. In examples disclosed herein, the user position analyzer 310 may determine a distance between the user and the display of the media device 112. In examples disclosed herein, the user position analyzer 310 may provide information corresponding to a position of the user to the virtual display calculator 350 for analysis and calculation of a virtual display in accordance with the teachings of this disclosure.

The example device position analyzer 320 analyzes a position or orientation of the media device 110. For example, the device position analyzer 320 may receive measurement information from sensors (e.g., gyroscopes, accelerometers, depth sensors, etc.) of the media device 110 via the sensor manager 230. The device position analyzer 320 provides measurement information (e.g., position information, orientation information, location information, etc.) to the virtual display calculator 350 for analysis. In some examples, the device position analyzer 320 may determine position information relative to a user or position information relative to a target surface (e.g., the target surface 106).

In the illustrated example of FIG. 3, the camera manager 330 serves as an interface of the virtual display projector 120 to communicate with a camera controller (e.g., the camera controller 220) of the media device 110. The example camera manager 330 may request an image stream from a camera (e.g. a rear-facing camera or camera on an opposite of the media device 110 as the display 112). The example image stream may be a continuous stream of images captured on a rear side of the media device (i.e., the side of the media device opposite the display 112). In examples disclosed herein, the image stream received by the virtual display projector 120 is used to virtually project or augment media onto a target surface (e.g., a wall, a desktop, a table, etc.) within the image stream. In examples disclosed herein, the camera manager 330 may monitor or receive measurement data from the user position analyzer 310 and the device position analyzer 320. In examples disclosed herein, the camera manager 330 may instruct a camera (e.g., a rear-facing camera of the media device 110) to adjust settings for capturing an image stream displayed by the display 112. For example, the closer a user is to the display 112, the wider a zoom may be up to a threshold. For example, if the user is within 10 inches of the display or closer a wide angle capture setting is be used. On the other hand, the further a user gets from the display, a narrower zoom (e.g., 1× zoom) or narrow capture angle (e.g., straight view) may be used to capture images (or video) for the image stream.

The image stream analyzer 340 of the example virtual display projector 120 of FIG. 3 analyzes an image stream from a camera (e.g., the rear-facing camera) of the media device 110. The image stream analyzer 340 may identify a target surface or target area to augment a display. Accordingly, the image stream analyzer 340 may include an image processor to measure or detect surfaces (e.g., walls, furniture tops, floors, ceilings, monitors, frames, screens, windows, etc.) that may be target surfaces for a virtual display. In some examples, a user may indicate (e.g., by tapping a touchscreen of the user interface 210 or outlining an area of a target surface, such as a wall or tabletop, etc.) a target surface of the image stream to be used. Example techniques such as edge detection, entropy, or any other suitable image processing technique may be used to identify a target surface. The example image analyzer 340 may provide information corresponding to the target surface to the virtual display calculator 350. For example the image stream analyzer 340 may provide characteristic information (e.g., coordinate location within the image stream, depth within the image stream, color, etc.) of the identified target surface in the image stream to the virtual display calculator 350. Accordingly, the image stream analyzer 340 determines information that enables the virtual display calculator 350, and thus the virtual display projector 120, to focus a resolution of the virtual display (or of media of the virtual display) such that the virtual display appears at a same depth of the display 112 as the target surface. Thus, from the characteristic information provided by the image stream analyzer 340, the virtual display projector 120 (e.g., via the virtual display calculator 350) may emulate (or simulate) a resolution for media (e.g., a video, an image, a document, an application, etc.) to be virtually displayed on the target surface in the image stream.

The example virtual display calculator 350 determines display settings for virtually projecting the media onto the target surface identified by the image analyzer 340. In examples disclosed herein, the virtual display calculator 350 utilizes information from the user position analyzer 310, the device position analyzer 320, the camera manager 330, and image stream analyzer 340 to calculate characteristics (e.g., position, shape, location, etc.) of a virtual display within the image stream. In examples disclosed herein, the virtual display calculator 350 monitors information from the user position analyzer 310, the device position analyzer 320, the camera manager 330, and image stream analyzer 340 and alters a display output for the display 112 based on a position of the user or a position of the device relative to the determined target surface identified in the image stream. The virtual display calculator 350 continuously monitors information corresponding to movement of the user or the display in order to adjust a display output (e.g., by adjusting a location of the virtual display within the image stream) for the media device 110 to maintain projection of the virtual display on the target surface. In other words, the virtual display calculator 350 adjusts display settings such that the virtual display is rendered within the image stream to appear static on the display 112 relative to movement of the user or the media device 110. In examples disclosed herein, the virtual display calculator 350 may focus or sharpen the projected virtual display within the image stream on the display 112 of the media device 110 in a similar fashion to a user's eyes refocusing between an object and a background of the object. Accordingly, in examples disclosed herein, the virtually projected display appears to be positioned on a target surface rather simply overlaying an image stream without any context of the background of the media device 110. The example virtual display calculator 350 may use any suitable mathematical formulas or algorithms to determine appropriate display settings to render the virtual display on the target surface in accordance with the teachings of this disclosure.

While an example manner of implementing the virtual display projector 120 of FIG. 1 or 2 is illustrated in FIG. 3, at least one of the elements, processes and/or devices illustrated in FIG. 3 may be combined, divided, re-arranged, omitted, eliminated and/or implemented in any other way. Further, the user position analyzer 310, the device position analyzer 320, the camera manager 330, the image stream analyzer 340, the virtual display calculator 350 and/or, more generally, the example virtual display projector 120 of FIG. 3 may be implemented by hardware and/or any combination of hardware and executable instructions (e.g., software and/or firmware). Thus, for example, any of the user position analyzer 310, the device position analyzer 320, the camera manager 330, the image stream analyzer 340, the virtual display calculator 350 and/or, more generally, the example virtual display projector 120 may be implemented by at least one of an analog or digital circuit, a logic circuit, a programmable processor, an application specific integrated circuit (ASIC), a programmable logic device (PLD) and/or a field programmable logic device (FPLD). When reading any of the apparatus or system claims of this disclosure to cover a purely software and/or firmware implementation, at least one of, the user position analyzer 310, the device position analyzer 320, the camera manager 330, the image stream analyzer 340, and the virtual display calculator 350 is/are hereby expressly defined to include a tangible machine readable storage device or storage disk such as a memory, a digital versatile disk (DVD), a compact disk (CD), a Blu-ray disk, etc. storing the executable instructions. Further still, the example virtual display projector 120 of FIG. 3 may include at least one element, process, and/or device in addition to, or instead of, those illustrated in FIG. B, and/or may include more than one of any or all of the illustrated elements, processes and devices.

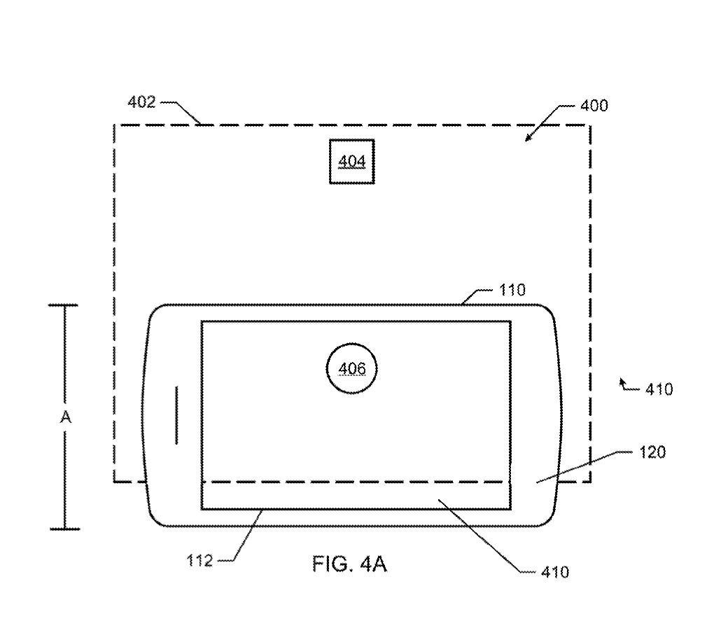

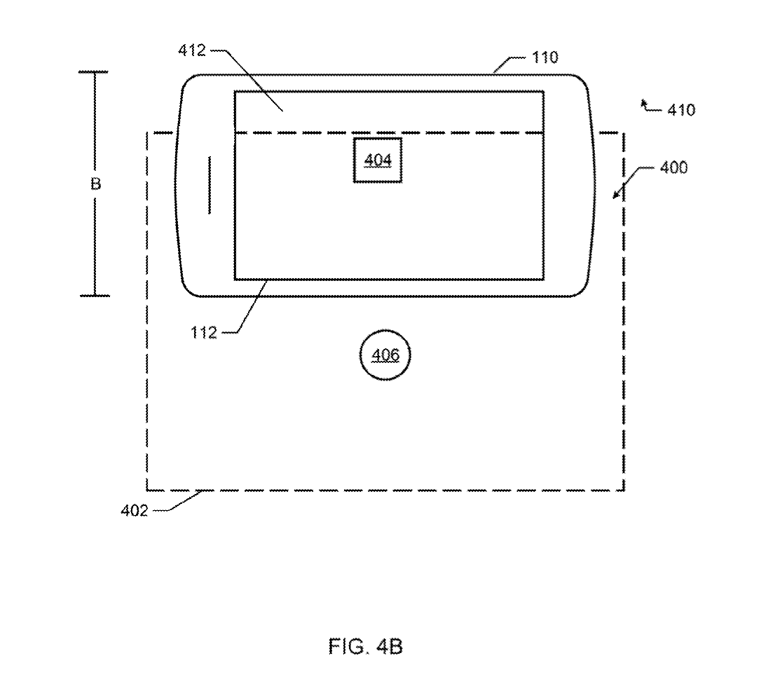

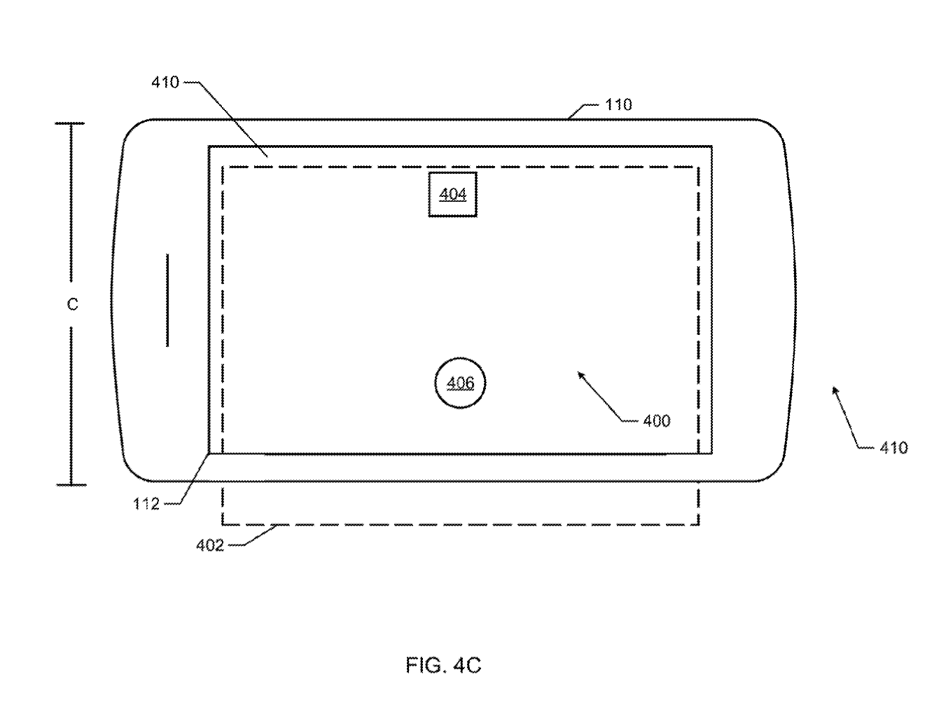

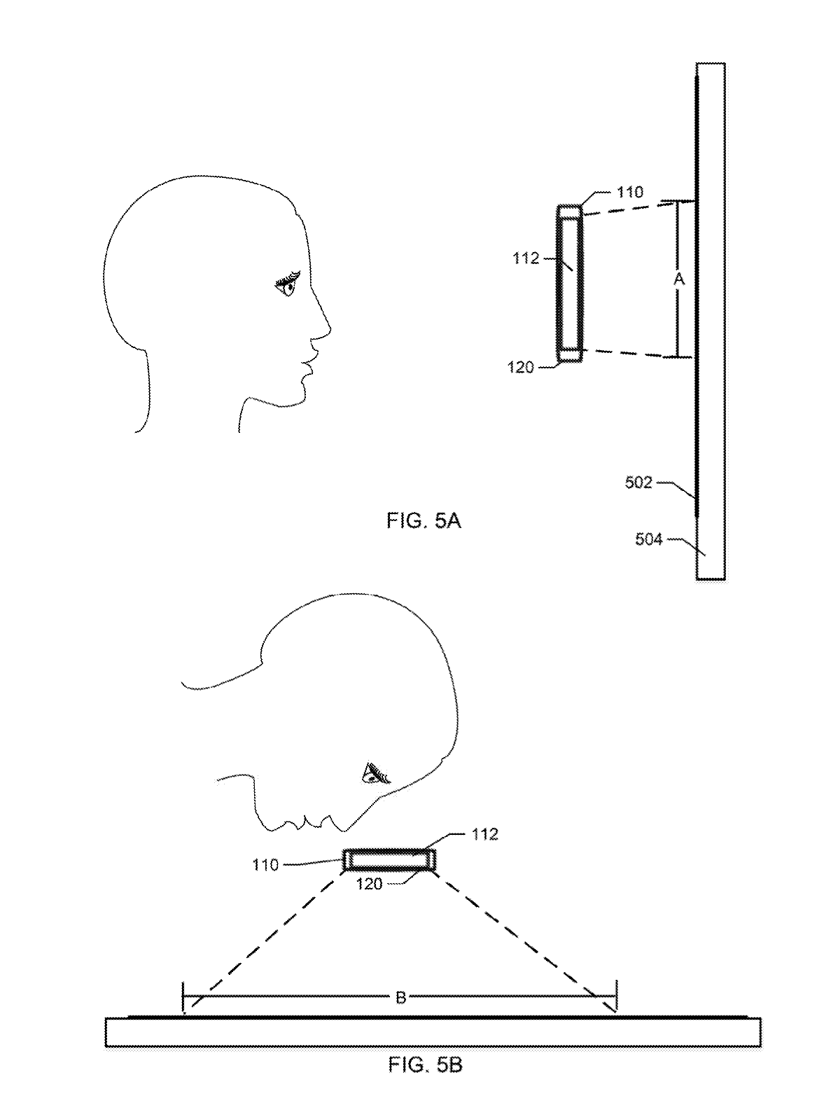

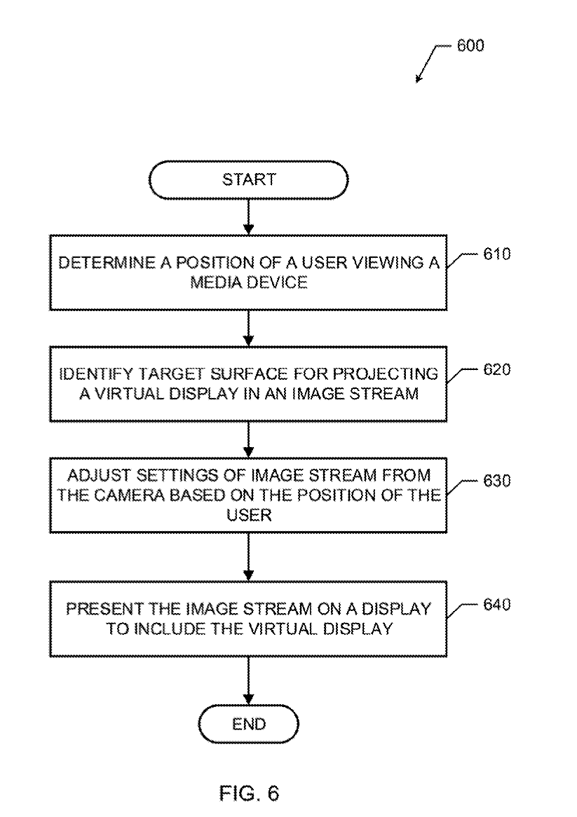

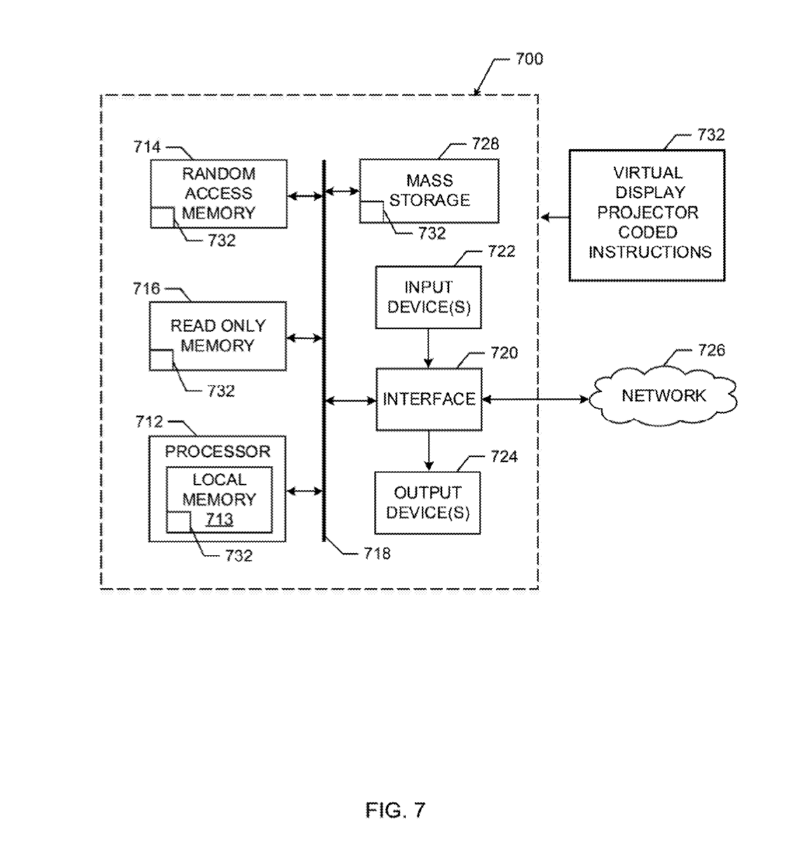

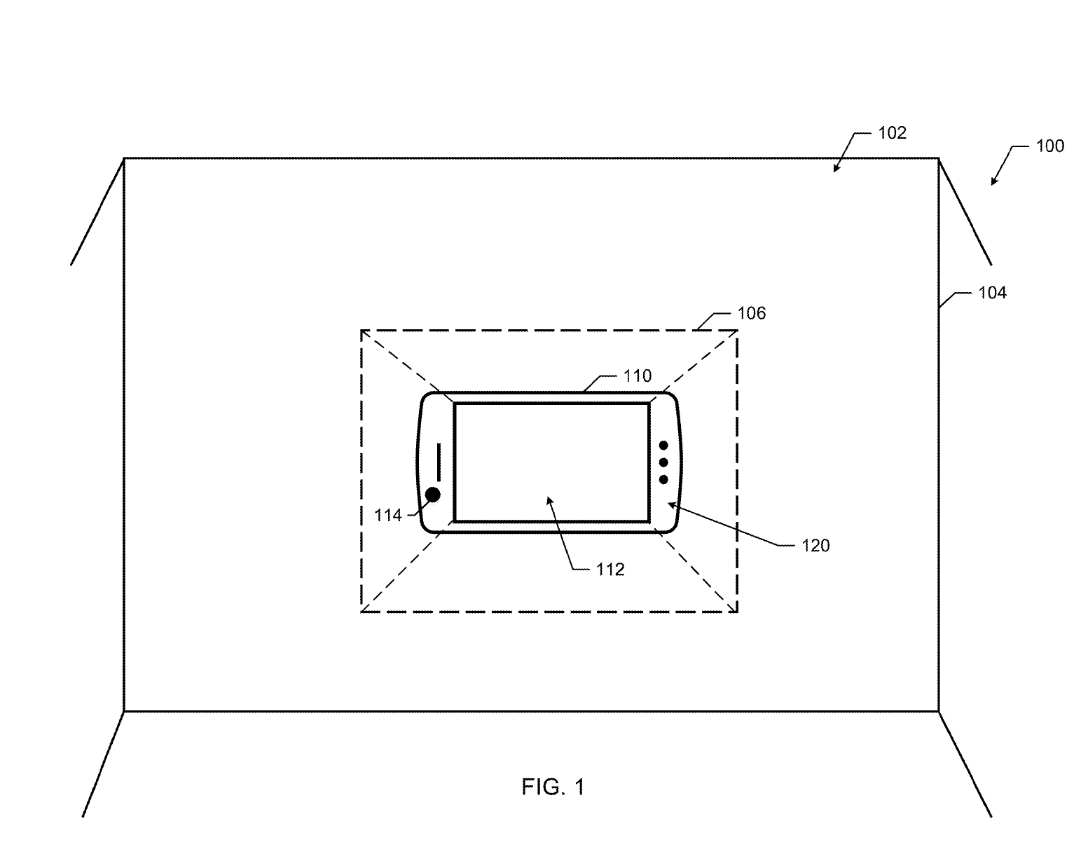

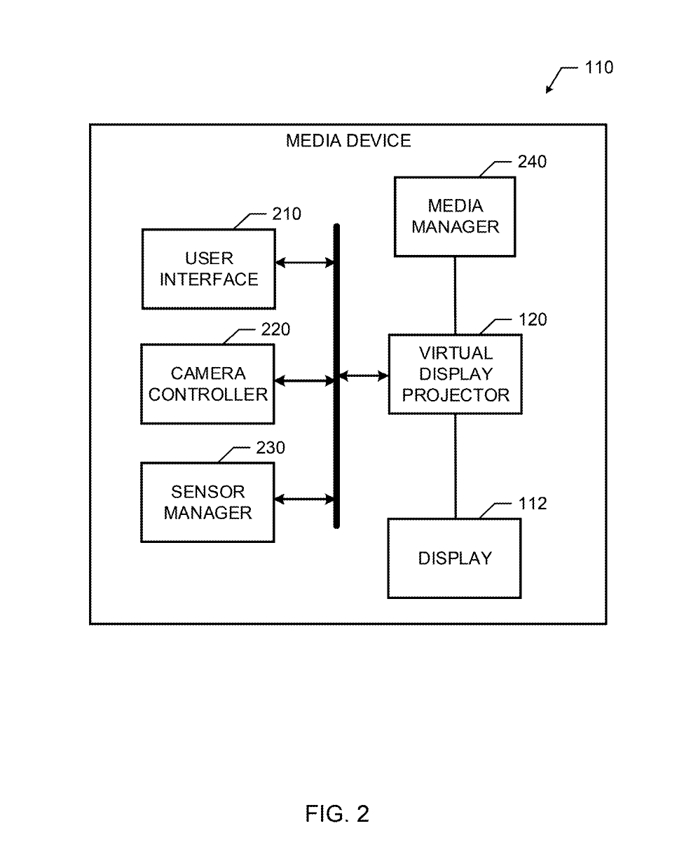

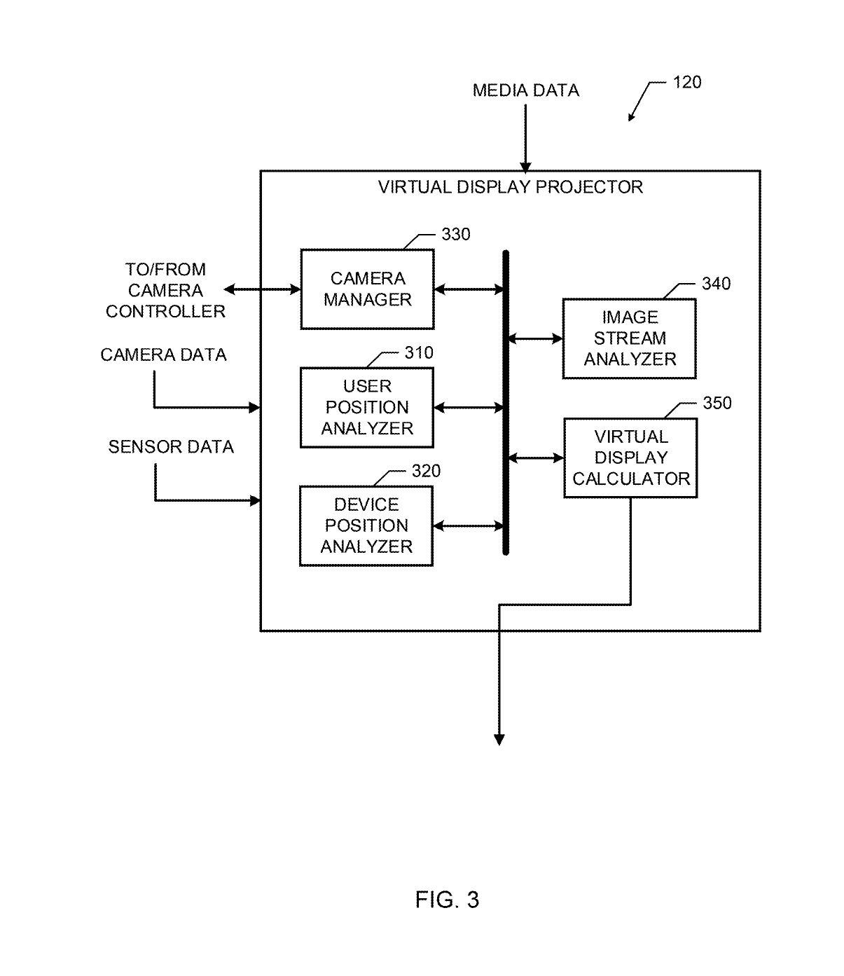

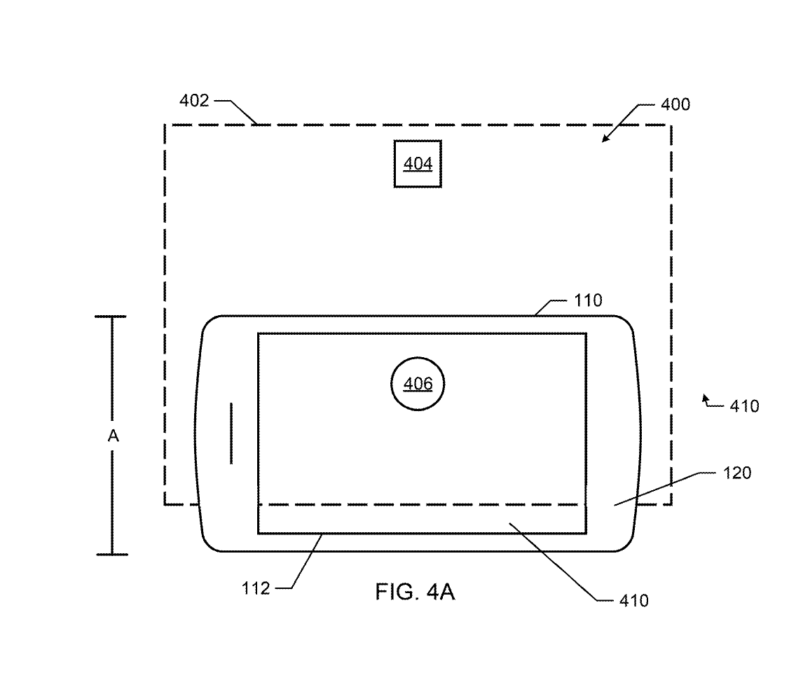

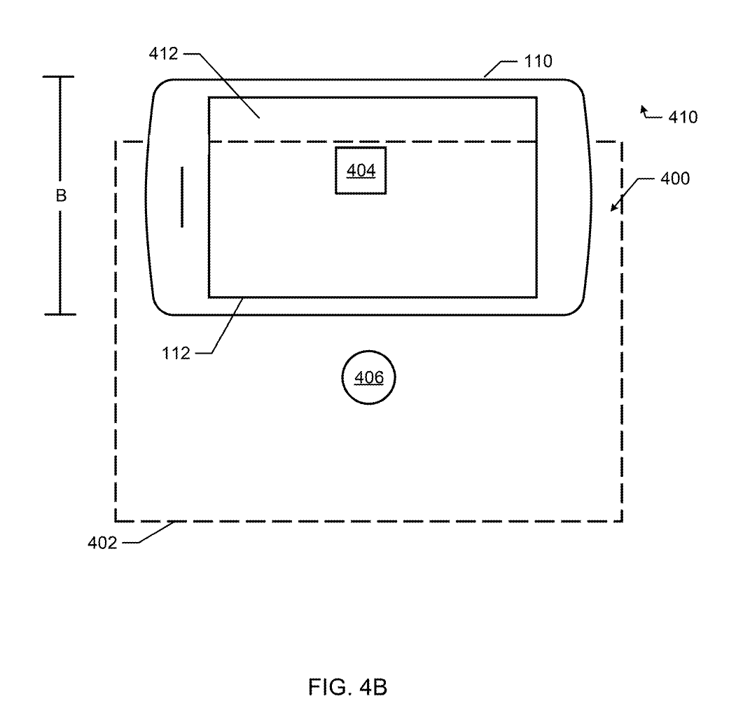

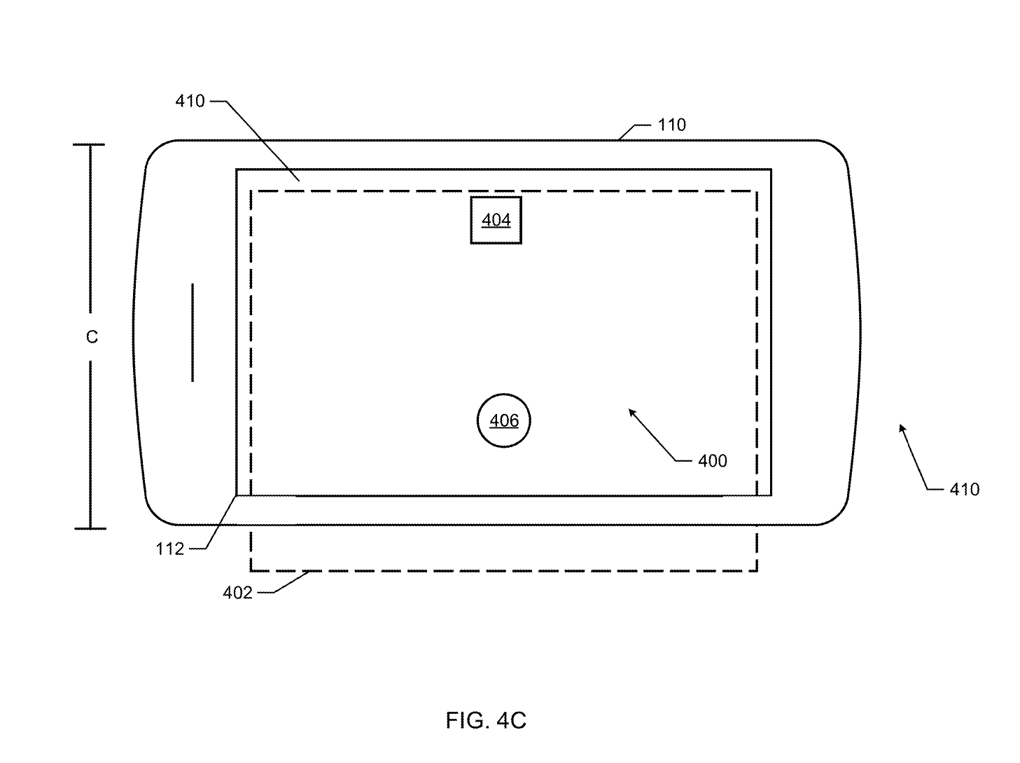

FIGS. 4A, 4B, and 4C illustrate an example virtual display projection 400 implemented by the example virtual display projector of FIG. 2 or 3. In the illustrated examples of FIGS. 4A and 4B, a media device 110 including the virtual display projector 120 is located at two different locations A and B, respectively, relative to the virtual display projection 400. Additionally, it can be assumed that in the illustrated example of FIGS. 4A and 4B, the media device 110 is positioned (e.g., held by a user) at the same distances between a user and the target surface 402. In some examples, the media device 110 of FIGS. 4A and 4B may be positioned at different distances between the user and the target surface 402. In FIG. 4C, as indicated by the size of the media device 110, it can be assumed that a user is positioned closer to the media device 110 than in FIGS. 4A and 4B. Although, in some examples, the media device 110 of FIG. 4C may be positioned at a same distance as the media device 110 of FIG. 4A or 4B.

In FIGS. 4A, 4B, and 4C the target surface 402 is identified against a background 410, which may be anything that is captured in an image stream by a rear-facing camera of the media device 110. For example, the target surface 402 may be a flat surface that is determined to be a particular distance from the media device 110 and the background may be the same flat surface, air, or any area that was not identified as a target surface. In examples disclosure herein, the target area 402 may be calculated or determined by an image stream analyzer (e.g., the image stream analyzer 340 based on characteristics of the target surface (e.g., size, distance from the media device 110, etc.). In examples disclosed herein, the virtual display projection 400 of FIGS. 4A-4C may have a background color such that the user may recognize the virtual display projection 400 on the target surface 402 against the background 410. In some examples, the virtual display projection may have a clear background such that the background 410 of the media device is visible on the target surface 402 except for the objects 404, 406.

In FIGS. 4A and 4B the virtual display projector 120 generates the virtual display projection 400 on the target surface 402. The example virtual display projection 400 in FIGS. 4A and 4B includes two objects, a square 404 and a circle 406. In the illustrated example of FIG. 4A, with the media device 110 located at position A, the display 112 of the media device 110 presents the circle 406 and but does not present the square 404 based on the position of the media device 110 relative to the target surface 402. Additionally, in FIG. 4A, the display 112 of the media device 110 presents a portion of the background 410 of the media device 110 as the media device is positioned over a portion of the target surface 402 that does not include the virtually projected display 400.

In FIG. 4B, if the media device 110 is moved to position B, the display 112 of the media device may present the square 404 but not the circle 406 as the media device 110 moved relative to the target surface 402. In other words, the virtual display projector 120 maintains a static virtual display on the target surface 402 such that when a device is moved, different portions of media virtually projected onto the target surface may be viewed. Additionally, the virtual display projection 400 remains static against the background 410 as indicated by a portion of the background 410 of the media device 110 displayed on the display 112.

FIG. 4C illustrates the media device 110 at location C. In FIG. 4C, the media device 110 is located closer to a user than in FIGS. 4A and 4B (as indicated by the size of the media device 110). Accordingly, based on the position of the media device 110 being closer to the user, the display 112 may present both the square 404 and the circle 406 along with a portion of the background 410, such that the virtual display projection 400 appears augmented over the background 410 of the media device 110.

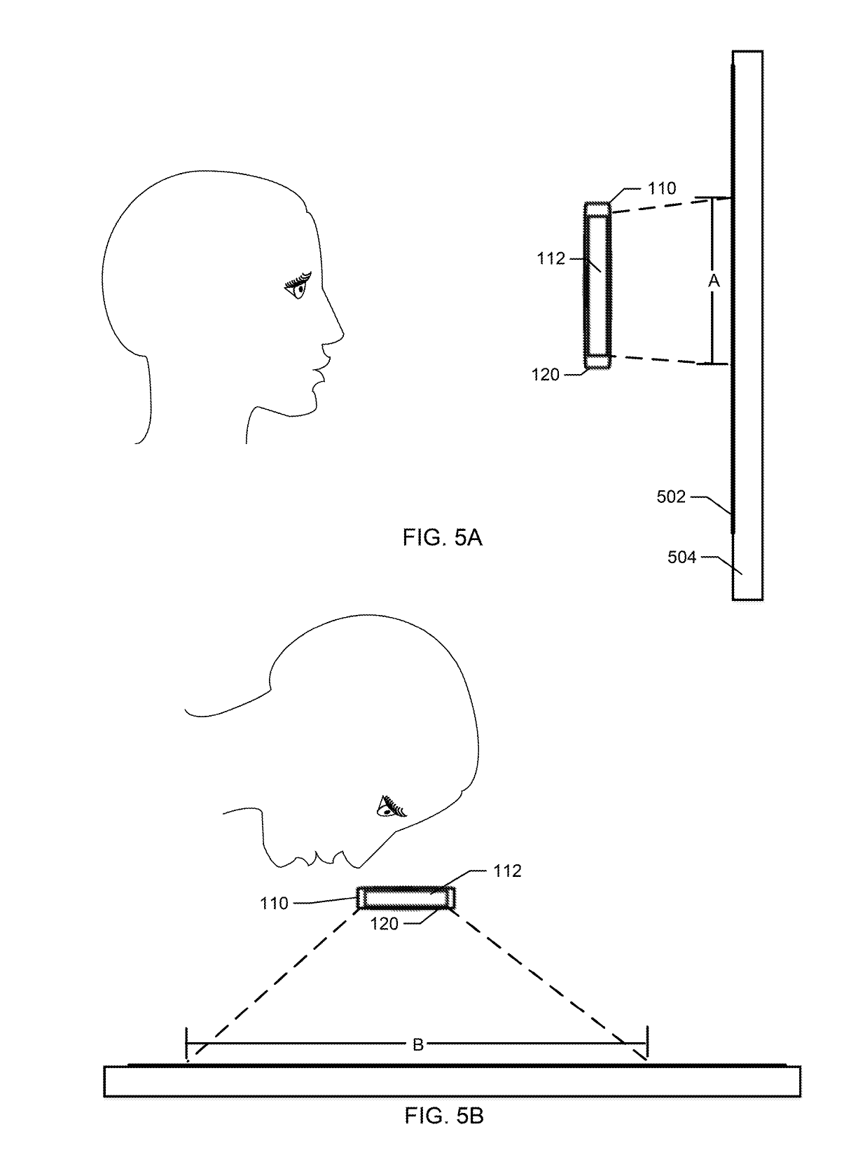

FIGS. 5A and 5B illustrate an example virtual display projection onto a target surface based on a distance between a user and a device implementing the virtual display projector of FIG. 2 or 3. In the illustrated example of FIG. 5A, the user is viewing a virtual projection on a display 112 of a media device 110 which may be implemented by the display 112 and the media device 110 of FIG. 2, respectively. In FIG. 5A, the user is located at a distance from the media device such that only a portion A of a virtual display 502 projected onto a target surface 504 can be seen. The example target surface 504 may be a wall. In the illustrated example of FIG. 5A, an example user position analyzer (e.g., the user position analyzer 310) of a virtual display projector 120 may provide user position information (e.g., a distance between the user media device 110 to a virtual display calculator (e.g., the virtual display calculator 350) to determine a portion of the virtual display 502 that is to be presented on the display 112. In some examples, in FIG. 5A, a camera may adjust image stream settings to capture a narrow angle (e.g., straight view) of the target surface 504 such that the target surface 504 does not appear distorted in the image stream, and the display 112 presents a portion of the virtual display 502 that would appear to be framed by the media device 110 at that distance (e.g., such that the media device 110 appears to be translucent when viewing the display 112).

However, in the illustrated example of FIG. 5B, the user is located closer to the media device 110. Therefore, in such examples, the user may see a greater portion B of the virtual display 502 on the target surface 504 due to adjusting image stream settings by capturing wide angle images of the target surface 504. The example target surface 504 of FIG. 5B may be a furniture top. As an example, in FIG. 5B, the user may be using the media device 110 to read an article or document projected on the virtual display 502. In FIG. 5B, camera settings may be adjusted to widen a camera angle (or zoom out) such that when the user is viewing the virtual display 502, more of the virtual display 502, may be included and presented on the display 112 (e.g., so that the user may look “through” the device 112 to see a greater portion of the article or document by viewing the adjusted image stream).

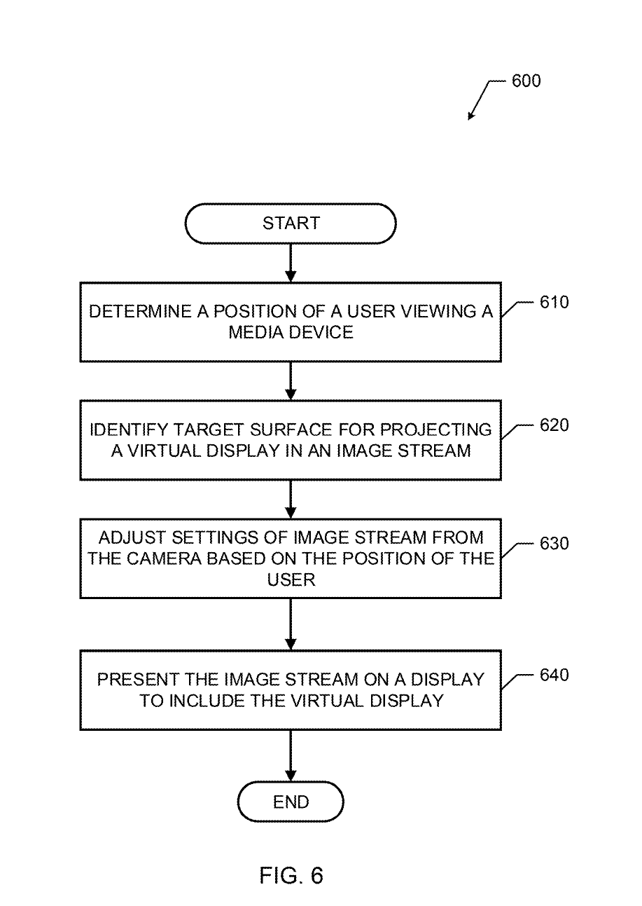

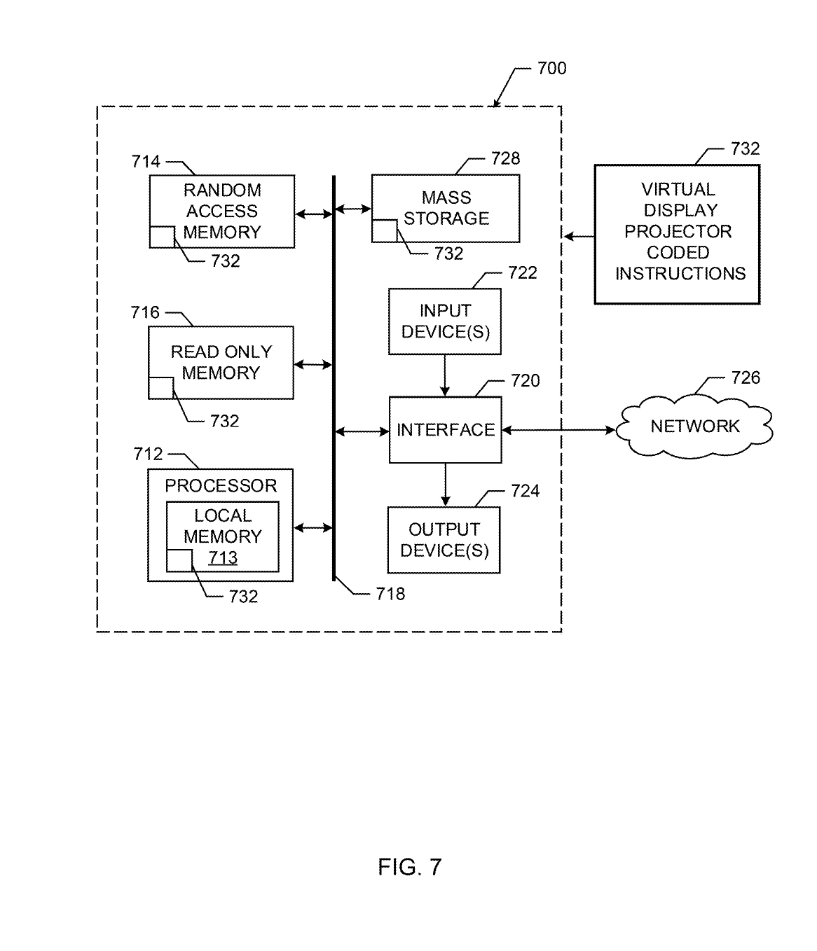

A flowchart representative of example machine readable instructions for implementing the virtual display projector 120 of FIG. 3 is shown in FIG. 6. In this example, the machine readable instructions comprise a program/process for execution by a machine, such as a processor (e.g., the processor 712 shown in the example processor platform 700 discussed below in connection with FIG. 7). The program/process may be embodied in executable instructions (e.g., software) stored on a tangible machine readable storage medium such as a CD-ROM, a floppy disk, a hard drive, a digital versatile disk (DVD), a Blu-ray disk, or a memory associated with the processor 712, but the entire program/process and/or parts thereof may alternatively be executed by a device other than the processor 712 and/or embodied in firmware or dedicated hardware. Further, although the example program is described with reference to the flowchart illustrated in FIG. 6, many other methods of implementing the example virtual display projector 120 may alternatively be used. For example, the order of execution of the blocks may be changed, and/or some of the blocks described may be changed, eliminated, or combined.

The example process 600 of FIG. 6 begins with an initiation of the virtual display projector 120 (e.g., upon startup, upon instructions from a user, upon startup of a device implementing the virtual display projector 120 (e.g., the media device 110), etc.). At block 610, the user position analyzer 310 determines a position of a user viewing a media device. For example, the position analyzer 310 may analyze images or sensor data (e.g., depth sensor data) to determine a location of a user or an eye gaze of the user. In some examples, at block 610, the device position analyzer 320 may determine a position of the media device relative to the user or a target surface identified in an image stream. The image stream analyzer 340, at block 620, identifies a target surface for projecting a virtual display in an image stream. For example, at block 620, the image stream may be from a rear-facing camera of the media device 110.

At block 630 of FIG. 6, the camera manager 630 adjusts settings of an image stream (e.g., by adjust camera settings, such as zoom, resolution, etc.) based on the position of the user. For example, if a user is located within a threshold distance of the media device, the zoom for the camera may be set to 1× such that when viewing the display and an image of what is behind the media device (e.g., the target surface), there is minimal (or no) distortion. At block 640, the virtual display calculator determines display characteristics such to present the image stream on a display to include the virtual display on the target surface. After block 640, the example process 600 ends.

As mentioned above, the example processes of FIG. 6 may be implemented using coded instructions (e.g., computer and/or machine readable instructions) stored on a tangible machine readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible machine readable storage medium is expressly defined to include any type of machine readable storage device and/or storage disk and to exclude propagating signals and to exclude transmission media. As used herein, “tangible machine readable storage medium” and “tangible machine readable storage medium” are used interchangeably. Additionally or alternatively, the example processes of FIG. 6 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory machine readable medium is expressly defined to include any type of machine readable storage device and/or storage disk and to exclude propagating signals and to exclude transmission media. As used herein, when the phrase “at least” is used as the transition term in a preamble of a claim, it is open-ended in the same manner as the term “comprising” is open ended. As used herein the term “a” or “an” may mean “at least one,” and therefore, “a” or “an” do not necessarily limit a particular element to a single element when used to describe the element. As used herein, when the term “or” is used in a series, it is not, unless otherwise indicated, considered an “exclusive or.”

FIG. 7 is a block diagram of an example processor platform 700 capable of executing the instructions of FIG. 6 to implement the virtual display projector 120 of FIG. 3. The example processor platform 700 may be any type of apparatus or may be included in any type of apparatus, such as a server, a personal computer, a mobile device (e.g., a cell phone, a smart phone, a tablet, etc.), a personal digital assistant (PDA), an Internet appliance, or any other type of computing device.

The processor platform 700 of the illustrated example of FIG. 7 includes a processor 712. The processor 712 of the illustrated example is hardware. For example, the processor 712 can be implemented by at least one integrated circuit, logic circuit, microprocessor or controller from any desired family or manufacturer.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be it by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), and/or a peripheral component interconnect (PCI) express interface.

In the illustrated example, at least one input device 722 is connected to the interface circuit 720. The input device(s) 722 permit(s) a user to enter data and commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

At least one output device 724 is also connected to the interface circuit 720 of the illustrated example. The output device(s) 724 can be implemented, for example, by display devices (e.g., a light emitting diode (LED), an organic light emitting diode (OLED), a liquid crystal display, a touchscreen, a tactile output device, a light emitting diode (LED), a printer and/or speakers). The interface circuit 720 of the illustrated example, thus, may include a graphics driver card, a graphics driver chip or a graphics driver processor.

The interface circuit 720 of the illustrated example also includes a communication device such as a transmitter, a receiver, a transceiver, a modem and/or network interface card to facilitate exchange of data with external machines (e.g., computing devices of any kind) via a network 726 (e.g., an Ethernet connection, a digital subscriber line (DSL), a telephone line, coaxial cable, a cellular telephone system, etc.).

The processor platform 700 of the illustrated example also includes at least one mass storage device 728 for storing executable instructions (e.g., software) and/or data. Examples of such mass storage device(s) 728 include floppy disk drives, hard drive disks, compact disk drive, Blu-ray disk drives, RAID systems, and digital versatile disk (DVD) drives.

The coded instructions 732 of FIG. 6 may be stored in the mass storage device 728, in the local memory 713 in the volatile memory 714, in the non-volatile memory 716, and/or on a removable tangible machine readable storage medium such as a CD or DVD.

From the foregoing, it will be appreciated that the, above disclosed methods, apparatus and articles of manufacture provide for presenting, on a display of a media device, a virtual display on a target surface in an image stream captured by a camera of the media device. Examples disclosed herein provide for an enhanced viewing experience by enabling a user to view media on a virtual display surface within a display of a media device. Accordingly, the virtual surface may provide for enhance resolution by providing an optical illusion to appear larger or clearer than a standard display. Examples disclosed herein may be implemented on a standard media device, such as a smartphone, tablet computer, PDA, etc. Examples further involve utilizing control of a camera to enable use of a non-transparent display and device.

Although certain example methods, apparatus and articles of manufacture have been disclosed herein, the scope of coverage of this disclosure is not limited thereto. On the contrary, this disclosure covers all methods, apparatus and articles of manufacture fairly falling within the scope of the claims of this disclosure.

What is claimed is:

1. A method comprising:
determining a position of a user viewing a display of a media device;
identifying a target surface for projecting a virtual display in an image stream from a camera of the media device;
adjusting settings for the image stream from the camera based on the position of the user; and
presenting the image stream on the display to include the virtual display such that the virtual display is to appear on the target surface in the image stream based on the position of the user.

2. The method as defined in claim 1, further comprising:
determining the position of the media device relative to the target surface for the virtual display, wherein the virtual display is to appear on the target surface further based on the position of the media device relative to the target surface.

3. The method as defined in claim 1, wherein adjusting settings from the image stream comprises adjusting a zoom of the camera.

4. The method as defined in claim 1, wherein the virtual display appears static on the target surface on the display when the position of the user changes or when the position of the media device changes relative to the target surface.

5. The method as defined in claim 1, the virtual display comprising media to be viewed by the user based on the position of the user and the position of the media device.

6. The method as defined in claim 5, wherein a portion of the media is not viewable when the user is greater than a threshold distance from the display.

7. The method as defined in claim 6, wherein the image stream comprises a straight view image captured by the camera.

8. The method as defined in claim 1, wherein the camera is a rear-facing camera and the image stream comprises images captured from a rear side of the media device, and the position of the user is determined using a front-facing image stream from a front-facing camera.

9. An apparatus, comprising:
a user position analyzer to determine a position of a user;
a device position analyzer to determine a position of a media device;
a camera manager to facilitate control of a camera based on the position of the user and the position of the media device, the camera to capture an image stream;
an image stream analyzer to analyze the image stream to identify a target surface on which to project a virtual display; and
a virtual display calculator to determine settings of the virtual display based on the position of the user and the position of the media device, the virtual display to be projected onto the target surface in the image stream and displayed on a display of the media device.

10. The apparatus as defined in claim 9, wherein user position analyzer analyzes images from a front-facing camera of the media device to determine the position of the user relative to the media device.

11. The apparatus as defined in claim 9, wherein the camera manager narrows or widens a capture angle of the camera based on the distance between the user and the display of the media device.

12. The apparatus as defined in claim 9, wherein the virtual display is rendered within the image stream to appear static on the display relative to movement of the user or the media device.

13. A non-transitory machine readable storage medium comprising instructions that, when executed, cause a machine to at least:
determine a position of a user relative to a display of a media device using a first camera of the media device;
identify a target surface from in the image stream captured by a second camera of the media device, the second camera to adjust settings for an image stream captured by the camera based on the position of the user; and
present the adjusted image stream on the display to include a virtual display projected onto the target surface.

14. The non-transitory machine readable storage medium of claim 13, wherein the target surface comprises at least one of a furniture top and a on an opposite side of the media device as the display.

15. The non-transitory machine readable storage medium of claim 13, wherein the instructions, when executed, further cause the machine to:
focus a resolution of the virtual display such that the virtual display appears at a same depth of the display as the target surface.
